(19) United States
(12) Patent Application Publication
(10) Pub. No.: US 2024/0184796 A1
(43) Pub. Date: Jun. 6, 2024

(54) CONTEXTUAL COACHING FEEDBACK BASED ON RECEIVED AND HISTORICAL MUSCULOSKELETAL KEY-POINTS

(71) Applicant: Uplift Labs, Inc., San Francisco, CA (US)

(72) Inventors: Rahul Rajan, Sunnyvale, CA (US); Jonathan D. Wills, San Mateo, CA (US); Sukemasa Kabayama, Mountain View, CA (US)

(21) Appl. No.: 18/076,342

(22) Filed: Dec. 6, 2022

(51) Int. Cl. G06F 16/248; G06F 3/01

(52) U.S. Cl. CPC G06F 16/248; G06F 3/01

(57) ABSTRACT

A system receives a pose sequence from a client device via a communication network. The pose sequence is a time series representation of a user performing a movement. The network system identifies various musculoskeletal key-points. The key-points describe the musculoskeletal structure of the user as she performs the movement. The system creates a data structure describing the time evolution of the key-points that represents the movement. The system inputs the data structure into a machine learning model to determine contextual feedback for the movement. To do so, the system compares the movement data structure to historical movement data structures and generates feedback for the movement based on differences between the input movement and the historical movement. The system generates the feedback according to user preferences.

### TECHNICAL FIELD

This disclosure relates generally to providing contextual feedback to a user for a pose sequence, and more specifically to codifying a pose sequence and comparing the codified pose sequence to historical pose sequence to determine contextual feedback for the pose sequence.

### BACKGROUND

Identifying various movements of an individual in an image or video has become commonplace due to advances in machine vision algorithms. As an example, one can look to motion capture and gesture recognition in modern video games. In this example, a user wears small identifying objects at key-points about their body while they execute various movements. A camera system obtains images of the user and utilizes the captured key-points to identify motions of the user, e.g., swinging a tennis racket, or throwing a punch in a boxing ring.

Even though motion identification has become relatively commonplace, providing contextual feedback for the identified motions is still a complex and unsolved problem. To provide context, a gaming system may be able to identify that a user has swung a golf club, but it is largely unable to provide feedback as to how to improve swinging mechanics for a particular user. There are lacking systems configured to provide contextual feedback for identified movements.

### BRIEF DESCRIPTION OF THE DRAWINGS

FIG. 1 illustrates a system environment for generating a feedback for a pose sequence, according to one example embodiment

FIG. 2 illustrates a client system, according to one example embodiment.

FIG. 3 illustrates a network system for generating feedback, according to one example embodiment.

FIG. 4 illustrates a workflow diagram showing a workflow implemented by the MI module to determine movements and determine feedback for that movement, according to an example embodiment.

FIGS. 5A-5C illustrate a series of images in a pose sequence received from a user, according to some example embodiments.

FIGS. 6A-6C illustrate a series of musculoskeletal images, according to some example embodiments

FIG. 7 illustrates a workflow for determining feedback for a pose sequence using the feedback module, according to one example embodiment.

FIG. 8 illustrates a workflow for determining feedback for a pose sequence using the feedback module, according to one example embodiment.

FIG. 9 is a block diagram illustrating components of an example machine for reading and executing instructions from a machine-readable medium, according to one example embodiment.

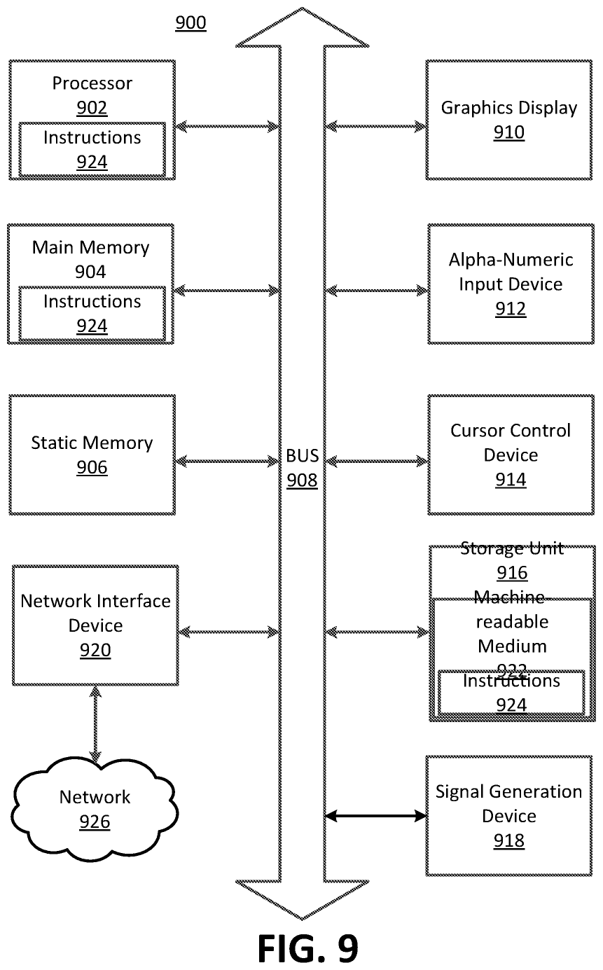

The figures depict various embodiments for purposes of illustration only. One skilled in the art will readily recognize from the following discussion that alternative embodiments of the structures and methods illustrated herein may be employed without departing from the principles described herein.

### DETAILED DESCRIPTION

The Figures (FIGS.) and the following description relate to preferred embodiments by way of illustration only. It should be noted that from the following discussion, alternative embodiments of the structures and methods disclosed herein will be readily recognized as viable alternatives that may be employed without departing from the principles of what is claimed.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

### Configuration Overview

In some configurations, the techniques described herein relate to a method including: receiving, at a network system from a client system, a pose sequence including a plurality of poses, the plurality of poses corresponding to a time-series of individual poses embodying a movement of a user, each pose representing a musculoskeletal structure of the user during the movement; generating a movement matrix including a set of musculoskeletal vectors representing the movement of the user, each musculoskeletal vector corresponding to a pose of the pose sequence, and each musculoskeletal vector representing the musculoskeletal structure of the user in the corresponding pose; determining feedback instructions for the pose sequence by inputting the movement matrix and a user state describing characteristics of the user into a feedback model, the feedback model configured to: quantify distances between the movement matrix and historical movement matrices in a historical cohort, the historical movement matrices representing historical users embodying the movement of users having a historical user state similar to the user; select a historical matrix having a closest distance to the movement matrix as a guidepost matrix; selecting at least one feedback item associated with the guidepost matrix as a contextual feedback item for the user; transmitting the contextual feedback item to the client system.

In some configurations, the techniques described herein relate to a method, further including: capturing a plurality of images of the user, the plurality of images representing a time series of individual poses embodying the movement of the user; and for each image in the plurality of images, codifying a pose represented in the image as a musculoskeletal vector representing the musculoskeletal structure of the user in the pose.

In some configurations, the techniques described herein relate to a method, wherein codifying the pose represented in the image as a musculoskeletal vector includes: inputting the image into a key-point identification model trained to input images of users executing movements and output a musculoskeletal vector representing movements executed by users in images.

In some configurations, the techniques described herein relate to a method, wherein: each historical movement matrix includes a set of historical musculoskeletal vectors representing a historical movement of a historical user, each historical musculoskeletal vector in the historical movement matrix corresponds to the pose of the pose sequence, and each historical musculoskeletal vector represents a musculoskeletal structure of the historical user in the corresponding pose.

In some configurations, the techniques described herein relate to a method, wherein selecting at least one feedback item associated with the guidepost matrix as the contextual feedback item for the user is based on user preferences for the user.

In some configurations, the techniques described herein relate to a method, wherein selecting at least one feedback item associated with the guidepost matrix as the contextual feedback item for the user includes: generating the at least one feedback item at the network system; and transmitting the at least one feedback item to the client system.

In some configurations, the techniques described herein relate to a method, wherein selecting at least one feedback item associated with the guidepost matrix as the contextual feedback item for the user includes: accessing the at least one feedback item from a feedback store at the network system; and transmitting the at least one feedback item to the client system.

In some configurations, the techniques described herein relate to a method, wherein selecting at least one feedback item associated with the guidepost matrix as the contextual feedback item for the user includes: accessing the at least one feedback item from a feedback store at the network system; modifying, using the network system, the at least one feedback; and transmitting the at least one feedback item to the client system.

In some configurations, the techniques described herein relate to a method, wherein the user state includes any of: an age of the user; a fitness level of the user; a skill level of the user; a sex of the user; a size of the user; and a weight of the user. In some configurations, the techniques described herein relate to a method, wherein the user state includes a movement goal of the user.

### I. Introduction

Providing high value contextual feedback to a user employing a movement identification system is a challenging problem. Current feedback techniques largely only provide analytics describing observed movements, but do not to provide feedback on how to effectively improve observed movements. For instance, a feedback system in the art may provide feedback as to how many repetitions a user has accomplished but is largely unable to provide feedback for the user as how to improve those repetitions. As described herein, systems and methods are used to identify and provide contextual feedback for an observed movement. The system includes a client system that captures images of a movement and transmits those images to a network system. The network system then codifies the movement and generates feedback for that movement by comparing the movement to historical movements.

### II. System Environment

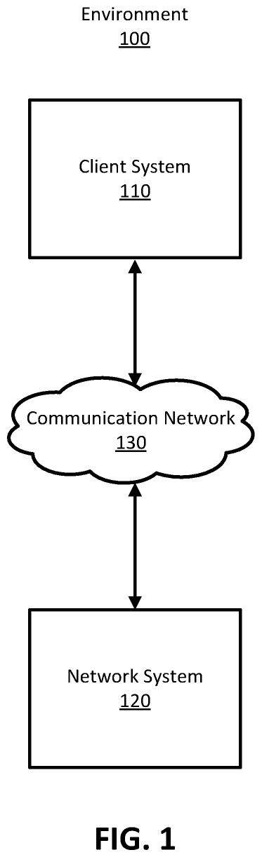

FIG. 1 illustrates a system environment for generating a feedback for a pose sequence, according to one example embodiment. In an embodiment, the system environment 100 (“environment”), includes one or more client systems 110 connected to a network system 120 via a communication network 130.

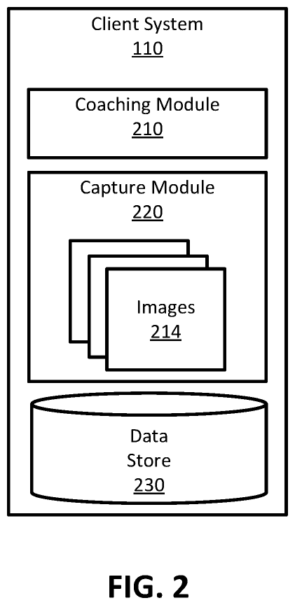

A client system 110 within the environment 100 records a pose sequence. A pose sequence is a series of images (or a video) representing a movement performed by a user. The client system 110 transmits the pose sequence (or a representation of the pose sequence) to the network system 120 via the communication network 130, and receives feedback for the pose sequence form the network system 120 via the communication network 130 in response. The client system 110 is described in more detail in regard to FIG. 2.

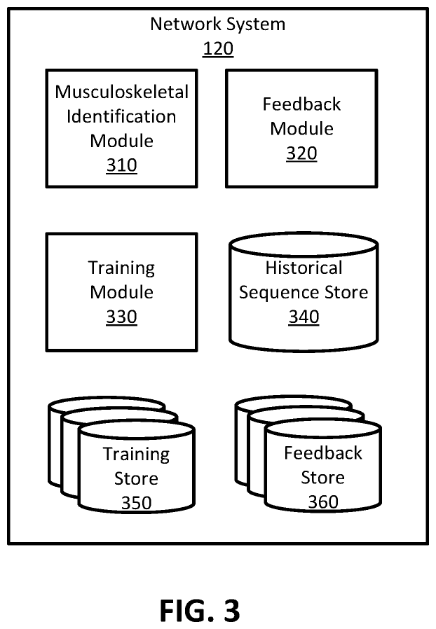

The network system 120 within the environment 100 receives a pose sequence from the client system 110 via the communication network 130, generates feedback for the pose sequence, and transmits feedback to the client system 110 via the communication network 130. Feedback is some form of information provided to a user tailored to improve the movement in the pose sequence. Typically, improving a movement may include increasing, decreasing, or modifying a quantifiable performance metric of the movement (e.g., speed, angle, etc.) embodied in the pose sequence. Improving a movement also may include increasing, decreasing, or modifying qualitative metrics (e.g., confidence, emotional state, etc.) embodied by the pose sequence. The network system 120 is described in greater detail in regard to FIG. 3.

The network system 120 is in communication with the one or more client systems 110 via the communication network(s) 130. In an embodiment, the communication network 130 is the Internet or any combination of a LAN, a MAN, a WAN, a mobile, wired or wireless network, a private network, or a virtual private network.

The environment 100 includes systems having a number of “modules.” For example, network system 120 may include various modules for performing tasks in generating feedback. Modules refer to hardware components and/or computational logic for providing the specified functionality. That is, a module can be implemented in hardware, firmware, and/or software (e.g., a hardware server comprising computational logic), other embodiments can include additional modules, can distribute functionality between modules, can attribute functionality to more or fewer modules, can be implemented as a standalone program or as part of a network of programs, and can be loaded into memory executable by processors.

Additionally, the environment 100 may have other embodiments. For example, in some embodiments, the environment 100 may include additional or fewer systems. To illustrate, the environment 100 may include numerous client systems 110 requesting feedback for a pose sequence, but may also include client systems 110 that determine feedback themselves. Further, the capabilities attributed to one system within the environment 100 may be distributed to one or more other systems within the system environment 100. For example, any or all of the functionality of the network system 120 may be accomplished by a client system 110.

### II.A Example Client System

A client system 110 records (or accesses) a pose sequence, and requests feedback on the pose sequence from the network system 120. FIG. 2 illustrates an example client system 110, according to one example embodiment. The client system 110 includes a contextual coaching module (“coaching module”) 210, an image capture module (“capture module”) 220, and a data store 230. In some embodiments, the client system 110 may include more or fewer modules, or the capabilities of the modules may be distributed to one or more other modules within the environment. For instance, any of the functionality described by the network system 120 may be performed by the client system 110.

The coaching module 210 provides an interaction interface between the user and the network system 120. For example, the coaching module 210 may be leveraged by a user of the client system 110 to transmit pose sequences to the network system 120 and receive feedback regarding the pose or pose sequence in response. To do so, the coaching module 210 may access an image or images from the capture module 220 or data store 230. The coaching module 210 also enables a user interface such that a user of the client system 110 may, for example, select pose sequences to transmit to the network system 120, interact with any feedback received from the network system 120, and update a user profile for the user.

The capture module 220 captures a pose sequence including a batch of images. The batch of images includes visual information that conveys the user in a series of poses during the performance of a movement. The capture module 220 includes one or more image and/or video capture devices (“capture devices”) configured to obtain images 214 in the pose sequence. In an embodiment, the capture device may be integrated into the client system 110. In other examples, the capture device may be external to the client system 110 and configured such that the capture device obtains a pose sequence which it provides to the client system 110. In some embodiments, the capture module 220 may also access a pose sequence from a data store 230 rather than capturing the pose sequence directly with a capture device.

Each captured image in the pose sequence includes information that can be used to determine feedback. The information includes both visual information and metadata information. Visual information includes pixels in the image that may represent the user, the user's movement, the space around the user, characteristics of the user's action, characteristics of the user, etc. The metadata information includes information describing the capture device (e.g., capture device settings and configuration), time information, label information (e.g., labeled to correspond to the user), etc.

To provide a contextual example, a client system 110 captures a pose sequence of a user performing a movement. Each image in the pose sequence includes an array of pixels conveying visual information. For example, each pixel in the image has a pixel value (e.g., an RGB value) which, in aggregate, form a visual depiction of the user performing the movement. Additionally, each image in the pose sequence (and/or the pose sequence in aggregate) is associated with metadata information. Here, the metadata information describes the capture device configuration, the time stamp of the image(s), and an identifier for the user capturing the image. As described below, information in the pose sequence can indicate appropriate feedback for the user action captured by the pose sequence.

The data store 230 stores information within the environment 100 on the client system 110. Stored information may include images in a pose sequence and its associated visual and metadata information. The stored information may also include a user state. The user state is information describing the user of the client system 110. The user state describes various characteristics and qualities of the user. For example, the user state may describe the age, fitness, skill level, sex, size, weight, health, health history, a score on a movement assessment, etc. of the user. The user state may also include the user's movement goals. Movement goals may include, e.g., desired movement performance increases, desired user state changes, etc. The stored information may also include user preferences. User preferences is information describing how a user prefers the network system 120 provides feedback. For example, the user may prefer video feedback, picture overlays, written communication follow-ups, frequent feedback, infrequent feedback, a threshold amount of feedback, etc. as a method of receiving feedback from the feedback module 320 of the network system 120. In various embodiments, the user state and user preferences may be stored in as user profile, and the user profile may be used by the client system 110 to generate feedback appropriate for the user.

### II.B Example Network System

As described above, the network system 120 generates feedback for a pose sequence and transmits that feedback to a client system 110. FIG. 3 illustrates a network system for generating feedback, according to one example embodiment. The network system 120 includes a musculoskeletal identification module (“MI module”) 310, a feedback module 320, a training module 330, a historical sequence store 340, a training store 350, and a feedback store 360. In some embodiments, the network system 120 may include more or fewer modules, or the capabilities of the modules may be distributed to one or more other modules within the environment 100. For instance, any of the functionality described by the network system 120 may be performed by the coaching module 210 or the client system 110.

### Example Musculoskeletal Identification Module

The MI module 310 is configured to determine a movement of a person in a pose sequence. For example, the MI module 310 identifies a movement of a user represented in the image, or images, of a pose sequence. To provide context, a movement may be a squat, a bicep curl, a jumping jack, a golf swing, a basketball shot, or other types of movement. Providing a contextual example, the MI module 310 may input a pose sequence and determine a user represented in the pose sequence is performing a golf swing based on the visual and metadata information for that pose sequence.

In identifying a movement in a pose sequence, the MI module 310 identifies musculoskeletal key-points (“key-points”) for each pose in the pose sequence. Key-points are one or more points that may be used to generate a musculoskeletal representation of a user. For example, the key-points may include ankles, knees, elbows, shoulder, etc. that represent the musculoskeletal structure of a user. The key-points can include a various number of points, such as, for example, five, ten, eighteen, thirty, or more. Key-points for each pose, or each image, may be represented as a data structure such as a vector. In turn, key-points representing evolution a movement in a post sequence, or across the series of images, may be represented as a data structure such as a vector or matrix. The MI module 310 may transmit the key-points to the client system 110 via a communication network 130.

Additionally, the MI module 310 may determine key-point analytics for each pose. Key-point analytics are quantitative and/or qualitative information describing the movement. The analytics may be determined using identified key-points in the pose sequence and/or changes in key-points between subsequent poses. As an example, descriptive analytics may describe relative locations of key-points, acceleration of a descriptive analytics may include a movement summary including number of repetitions, weight lifted, movements executed, speed of movements, or similar. Notably, in some configurations, identifying one or more key-point analytics may be accomplished by the network system 120 as described below. The MI module 310 may transmit the key-point analytics to the client system 110 via a communication network 130.

### Example Feedback

To determine feedback for a pose sequence, the feedback module 320 is configured to determine contextual feedback for a given pose sequence configured to improve the user's movement. Information provided as feedback may take many forms. For instance, the feedback may be audio, video, text, etc., depending on the configuration of the network system 120. Moreover, feedback may be accessed (e.g., from the internet via the network, from a datastore, etc.), generated (e.g., drafting an email, creating an audio file, etc.), or modified (e.g., adding audio to a video of a pose sequence, providing sound cues for a user, etc.), depending on the configuration of the environment 100. Additionally, feedback may be accessed, generated, or modified from anywhere within the environment. 000 For instance, feedback may be stored and accessed from a feedback store 360 on the network system 120, received from a client system 110, or modified from some other network source.

### Determining Feedback for a Received Pose Sequence

To determine feedback for a received pose sequence, the feedback module 320 inputs the pose sequence, key-points and key-point analytics for the pose sequence, user state information, and user preferences into the feedback module 320 and the feedback module 320 generates feedback based on that information.

To determine feedback for a given pose sequence, the feedback module 320 compares input information for the received pose sequence to a historical cohort. The historical cohort includes a set of historical pose sequences. The historical pose sequences may be stored in the historical sequence store 340. The historical pose sequences may describe a variety of movements, and the network system 120 may be configured for providing feedback for each of those movements. Each historical pose sequence is associated with its corresponding key-points, key-point analytics, and user state. Additionally, each historical pose sequence may be associated with various feedback for that pose sequence. The comparison process may include determining key-points, e.g., body joint locations, on the captured pose sequences and comparing those key-points to similar key-points of historical pose sequences.

In some configurations, each historical pose sequence may be segmented into a series of key-poses. Key-poses in a pose sequence embody a series of poses that are key in performance of the movement embodied by the movement in the pose sequence. For example, key-poses in a pose embodying a golf swing may be, e.g., back-swing, top-swing, downswing, impact, and follow through. Each key-pose in a pose sequence may be associated with its corresponding key-points, key-point analytics, and user state. Additionally, each key-pose in a historical pose sequence may be associated with various feedback for that pose sequence.

There are several methods to generating feedback for a pose sequence leveraging pose sequences in the historical sequence store.

In a first example, the feedback module 320 quantifies a distance between the received pose sequence and historical pose sequences in the historical cohort. The distance between pose sequences may be quantified in a variety of manners such as, e.g., a cosine similarity, Jaccard similarity, nearest neighbor algorithms, etc. Calculating the distance may be based on differences between any of the key-points, key-point analytics, touchpoints, and user state information between the received and historical pose sequences. In effect, the closeness between a received pose sequence and a historical pose sequence quantifies the similarity between the movements embodied by those pose sequences. As such, quantifiably close pose sequences, i.e., similar movements, are expected to warrant similar feedback.

The feedback module 320 identifies the closest historical pose sequence to the received pose sequence as a guidepost pose sequence. The guidepost pose sequence is the pose sequence from the historical cohort from which feedback for the received pose sequence is modeled. For example, the feedback module 320 may provide the feedback associated with the guidepost pose sequence to the user because the movement embodied by the corresponding historical pose sequence and the received pose sequence are similar.

In a second example, the feedback module 320 identifies key-poses for the received pose sequence. The feedback module 320 calculates a distance, or distances, between the key-poses in the received pose sequence and the corresponding key-poses for historical pose sequences in the historical cohort. Depending on the configuration, the feedback module 320 may calculate a distance based on a single key-pose (e.g., just a backswing), combination of key-poses (e.g., backswing and follow through), or all of the key-poses (e.g., an entire golf swing). In effect, the closeness between a received key-pose for a pose sequence and its corresponding key-pose in a historical pose sequence quantifies the similarity between those key-poses for a movement embodied by those pose sequences. As such, quantifiably close key-poses, i.e., similar poses within the movement, are expected to warrant similar feedback.

The feedback module 320 identifies the closest historical key-pose (or key-poses) to the received key-pose (or key-poses) as the guidepost key-pose. The guidepost key-pose is the key-pose from the historical cohort from which feedback for the received key-pose sequence is be modeled. For example, the feedback module 320 may provide the feedback associated with the guidepost key-pose to the user because the movement embodied by the historical key-poses and the received key-poses sequence are similar. Segmenting a pose sequence into key-poses in this manner and calculating distance based on key-poses (rather than an entire pose sequence) allows a user to receive key-pose specific feedback.

### Generating Feedback According to User Preferences

In either case, the feedback module 320 generates feedback for the user using the identified guidepost pose sequence (or guidepost key-pose(s)), user state, and user preferences. To illustrate, recall again that each historical pose sequence (or historical key-pose) is associated with feedback. As such, each guidepost pose sequence or guidepost key-pose is also associated with that feedback. The feedback module 320 generates feedback for the pose sequence from the feedback associated with the guidepost pose sequence (or guidepost key-pose) based on the user state and/or user preferences. For example, the feedback module 320 may select feedback for the received pose sequence from the feedback for the guidepost pose sequence such that the feedback adheres to the user preferences. For example, the user preference may define that the user prefers video feedback and the feedback module 320 may accordingly generate video feedback. Similarly, the feedback module 320 may select feedback for the received pose sequence from the feedback for the guidepost pose sequence such that the feedback appropriate for the user state. For example, the feedback module may generate different feedback if a user state indicates a user is a man or woman, overweight or underweight, seeking to improve cardiovascular health or anabolic strength, etc.

In some embodiments, the feedback module 320 may generate new feedback, modify existing feedback, or access additional or different feedback such that it adheres to the user preferences. In this case, the feedback module 320 may use the guidepost feedback as a reference point for generating new feedback or modify the guidepost feedback based on the user preferences. The feedback module 320 provides generated feedback to the client system via the network.

### Generating Feedback Based on Identified Movement Deficiencies

As described above, the feedback module 320 is configured to generate feedback in a manner that improves a user's performance of a movement embodied by a pose sequence. This idea can be expanded to generate feedback for an identified movement deficiency across multiple pose sequences. For instance, consider a user who has transmitted a pose sequence relating for a golf swing and a pose sequence for a basketball shot. The feedback module 320 is configured to generate feedback for those pose sequences based on the latent information identified in those pose sequences relative to historical pose sequence. Given that the user has two pose submitted two pose sequences, the feedback module may be configured to identify a movement deficiency for the user based on the classification and determined feedback for both poses. For instance, the feedback module may determine from the pose sequences (and/or the determined feedback for those pose sequences) that the user has limited mobility in their wrists given that the pose sequences (and/or determined feedback) for both movements indicate limited wrist mobility. As such, the feedback module may generate feedback for the user to increase wrist mobility generally, rather than wrist specific feedback for each movement individually. More simply, the feedback module 320 is trained to identify and correlate similar movement deficiencies for a user across all of their pose sequences in order to tailor feedback for that user.

### III. Generating Feedback for a Pose Sequence

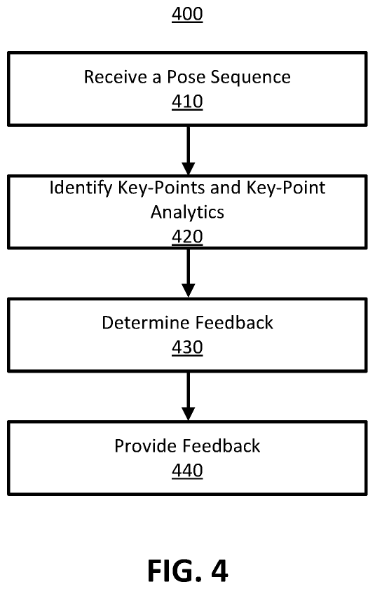

FIG. 4 illustrates a workflow diagram showing a workflow implemented by the MI module to determine movements and determine feedback for that movement, according to an example embodiment. The workflow may include additional or fewer steps, and the steps may occur in a different order. Moreover, the described steps may repeat or may be omitted depending on the context and implementation of the MI module and the type of feedback it generates.

The network system 120 receives 410 a pose sequence from a user. In an embodiment, the pose sequence is a series of images 214 captured by the capture module 220 of a client system 110. The series of images 214 represent a pose sequence. That is, each image in the series of images represents the various stages of a movement taken by a user.

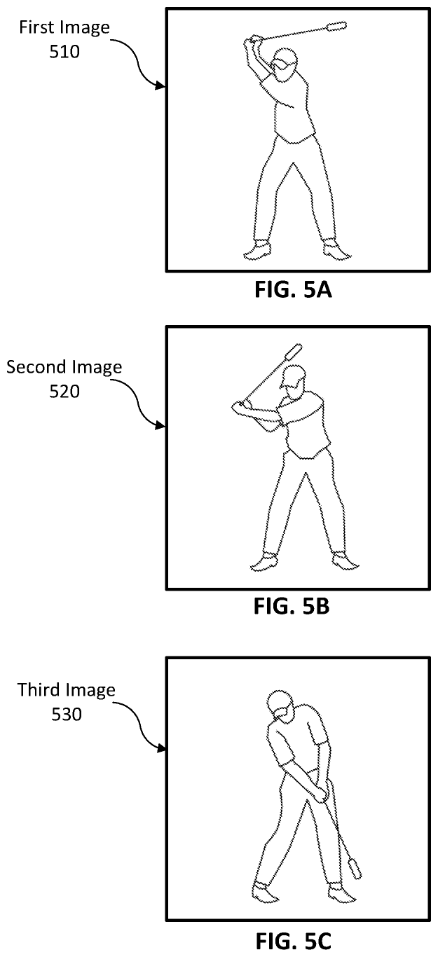

FIGS. 5A-5C illustrate a series of images in a pose sequence received from a user, according to some example embodiments. The pose sequence includes images of the user executing a golf swing. Each image comprises an array of pixels showing the user and her golf club. Because the images are taken over a period of time, the images represent the evolution of the user's golf swing.

As context, FIG. 5A is a first image of a pose sequence, according to one example embodiment. The first image 510 of the pose sequence is an image of the user at the top of her backswing when driving a golf ball. FIG. 5B is a second image of a pose sequence, according to one example embodiment. The second image 520 of the pose sequence is an image of the user in her down swing when driving the golf ball. The second image in the pose sequence occurs at a time after the first image in a pose sequence. FIG. 5C is a third image in a pose sequence, according to one example embodiment. The third image 530 in the pose sequence occurs at a time after the second image in the pose sequence. Thus, the pose sequence provides snapshots showing a temporal evolution of the user's golf swing. As described herein, the network system 120 can determine feedback for the user's golf swing based on the latent information in the pixels of the images in the pose sequence and any analytics derived from that latent information.

Returning to FIG. 4, the network system 120 employs the MI module 310 to identify key-points and their associated key-point analytics for poses in the pose sequence. That is, the MI module 310 inputs images in the pose sequence and identifies various key-points in the image by analyzing the latent information in those images. The MI module 310 may also generate various analytics describing the key-points, such as, e.g., speed, acceleration, location, etc., of the various key-points.

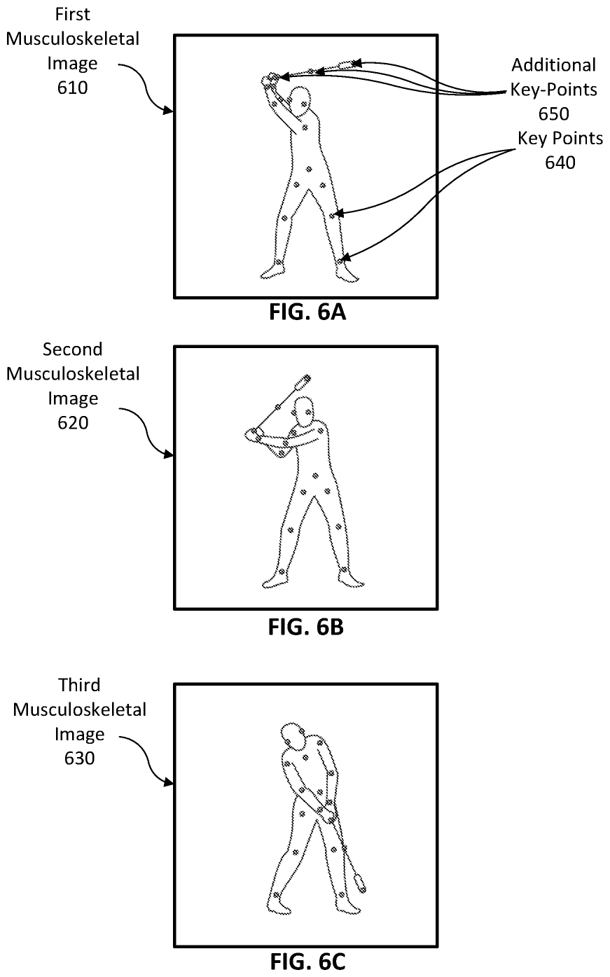

For example, FIGS. 6A-6C illustrate a series of musculoskeletal images, according to some example embodiments. Each musculoskeletal image corresponds to the pose sequence in FIG. 5A-5C.

For instance, FIG. 6A is a first musculoskeletal image derived from the first image in the received pose sequence (i.e., FIG. 5A), according to one example embodiment. The first musculoskeletal image 610 shows the key-points identified by the MI module 310 in the first image 510. FIG. 6B is a second musculoskeletal image derived from the second image in the received pose sequence (i.e., FIG. 5B), according to one example embodiment. The second musculoskeletal image 620 shows the key-points identified by the MI module 310 in the second image 620. Finally, FIG. 6C is a third musculoskeletal image derived from the third image in the received pose sequence (i.e., FIG. 5C), according to one example embodiment. The third musculoskeletal image 630 shows the key-points identified by the MI module 310 in the first image 530.

Each of the musculoskeletal images, e.g., 610, 620, and 630, include a set of key-points (e.g., key-points 640). The set of key-points 640 indicate the position of various points of the user during her golf swing. For example, the key-points 640 include the position of the users shoulders, hips, knees, etc. Each of the musculoskeletal images may also include the position of various additional key point 650. As illustrated the additional key-points are points describing the golf club handle, shaft, head, etc. In other sporting contexts, the key-points may reflect the position of other objects (e.g., tennis racket, hockey stick, baseball bat, weights, etc.). The identified key-points 640, 650 may be indicative in generating feedback for the user (e.g., if one of the poses reflected by the key-points is a deviant pose).

As described above, each of the musculoskeletal images may also be associated with their corresponding key-point analytics. For example, they key-point analytics for a musculoskeletal image may include an angle between several key-points, a velocity of a musculoskeletal point, an acceleration of a musculoskeletal point, a time stamp of the musculoskeletal image, etc. The key-point analytics may be indicative in generating feedback for the user.

Additionally, depending on the configuration of the network system 120, other musculoskeletal images may include different information than that illustrated here. For example, information in a musculoskeletal image of a person executing a fencing maneuver may different than that of a person executing a powerlifting maneuver (i.e., the key-points indicative of feedback for a fencer may be different than that of a powerlifter). Moreover, musculoskeletal images may not be an actual image. That is, a musculoskeletal image may be a data structure including the set of key-points and their associated key-point analytics (e.g., a vector). The data structure can also represent the time evolution of the key-points (e.g., a matrix).

In other words, on a broad level, the musculoskeletal images described herein more generally represent a method codifying a pose sequence. In an embodiment, each image from a pose sequence is codified as a musculoskeletal vector including musculoskeletal points representing the musculoskeletal structure of the user in the pose. As such, the series of images in a pose sequence corresponds to a series of musculoskeletal vectors, which may be combined into a musculoskeletal matrix. The musculoskeletal matrix thereby represents a time-evolution of the movement of the user represented in the images of the pose sequence.

Returning to FIG. 4, the network system 120 determines feedback for a received pose sequence. To expand, the network system 120 inputs a pose sequence, processes that pose sequence to identify its key-pose(s), generates feedback for those key-pose(s) and generates feedback for the key-pose(s) based on information within the environment 100 as described herein.

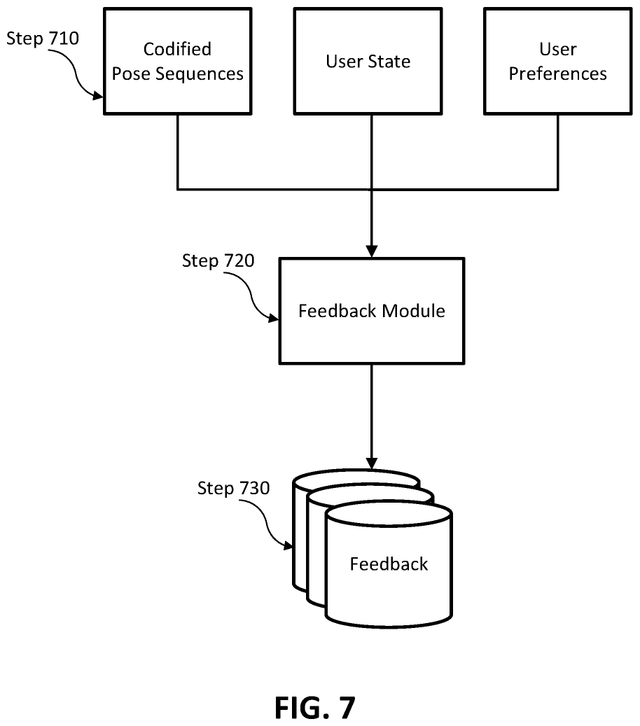

FIG. 7 illustrates a workflow for determining feedback for a pose sequence using the feedback module, according to one example embodiment. The workflow 700 may include additional or fewer steps, and the steps may occur in a different order. Moreover, the described steps may repeat or may be omitted depending on the context and implementation of the network system 120.

At step 710, the network system 120 inputs codified pose sequences, the user state, and the user preferences into the feedback module 320. Codified pose-sequences are the data structures reflecting the key-points and key-point analytics of the movement embodied in the pose sequence (e.g., vectors and or matrices). The user state describes various characteristics and qualities of the user and the user preferences describe various preferences the user may have regarding how the feedback module 320 provides feedback. In some configurations, the network system 120 may determine feedback using additional or less information than what is illustrated. For example, the network system 120 may determine feedback using only codified pose sequences and a user state, or the network system 120 may determine feedback when taking into account the configuration of the client system 110.

In various configurations, the network system 120 may access and/or receive the information for generating feedback information as needed within the environment 100. For example, the network system 120 may access a user state from a data store on the network system 120, or may receive the user state from a client system 110. Whatever the case, the network system 120 is configured to access information within the environment 100 such that it may provide tailored feedback to a user.

At step 720, the network system 120 employs the feedback module 320 to determine feedback for the pose sequence. Generally, determining feedback includes selecting feedback for the user based on the various information input into the feedback module 320 such that the selected feedback is tailored to the user based on the received codified pose sequence, the user state, and the user preferences. The determined feedback is typically feedback associated with a historical pose sequence closest in distance to the codified pose sequence. In various configurations, generating feedback may include inputting the received information into a machine learned model as described below.

At step 730, the network system 120 generates feedback based on feedback determined to be relevant to the received post sequence (e.g., a closest distance historical pose sequence). As described above, providing the determined feedback may include accessing, modifying, or creating feedback aligning to whatever feedback is generated by the feedback module 320. This may include leveraging (i.e., accessing, referencing, manipulating, etc.) feedback stored in the feedback data store.

Continuing the contextual example from above, the user executing the golf swing stores information describing her user state (e.g., a user profile) on her client system and/or the network system 120. The user state includes information describing her, height, weight, injury, ability level (i.e., player handicap), submitted pose (e.g., driving), etc. The user also stores information describing her feedback preferences. For example, the user may prefer to receive an email indicating methods of improving her movement, e.g., an email including instructions on how to correct her hip alignment during her downswing. In another example, the user may prefer a video showing feedback rather than adios. For example, the network system 120 may transmit a URL to a video describing exercises she can participate in to correct the velocity of her club head at ball impact. Other examples are also possible.

Returning to FIG. 4, the network system 120 provides feedback for the received pose sequence to the user. To expand, the network system 120 inputs a pose sequence from a client system, processes that pose sequence to identify key-points and key-point analytics, determines feedback based on the key-points and key-point analytics by comparing them to a historical cohort, and provides 440 the feedback to the client system requesting the feedback.

### Machine Learning Processes in Determining Feedback

As described above, the network system 120 includes various modules (e.g., MI module 310, feedback module 320) to identify key-points and key-point analytics for a pose sequence, and determine and generate feedback for those pose sequences. In various embodiments, the modules described herein may employ a machine learning model to accomplish their corresponding functionality.

For instance, in an example embodiment, the MI module 120 may employ a machine learned model (“key-point identification model”) similar to the MI module described in U.S. Pat. No. 11,003,900 titled “Identifying Movements and Generating Prescriptive Analytics Using Movement Intelligence,” filed on Feb. 20, 2019, all of which is hereby incorporated herein. In brief, he key-point identification model is a convolutional neural network implementing an image segmentation model that identifies key-points and key-point analytics, but other types of classifier models are also possible. Within this configuration the input vector (or vectors) is a pose sequence (e.g., a vector representing the pose sequence, images comprising the compose sequence) and the output is a pose sequence signature (e.g., a lower dimensional representation of the pose represented by the input vector).

Additionally, in an example embodiment the feedback module 120 may employ a machine learned model (“feedback identification model”). In an example, the feedback identification model is a knowledge graph representing the relationship between various movements and their associated feedback. Within this context, the feedback identification model inputs, for example, a pose sequence signature and outputs feedback associated with that pose sequence signature. Stated differently, the pose sequence signature “queries” the feedback identification model and the feedback identification model outputs feedback as a result of the query.

In querying the feedback identification model with a pose sequence signature, the model identifies feedback for a pose sequence signature within its structure (e.g., a historical pose sequence) that is “close” to the received pose sequence signature. Determining that a pose sequence is close to a historical pose sequence is described hereinabove. The closeness of the two pose sequences may be based on the lower dimensional representation of the key-points and key-point analytics. The closeness of two pose sequences may also be based on the user state associated with the pose sequences, for example, based on whether or not the received pose sequence is from a male or female. Whatever the inputs, the feedback identification model is built from the various relationships between pose sequence signatures, various user state information, and the associated feedback. Accordingly, the feedback identification model will output feedback best tailored for the particular received pose sequence and user state information given the structure of the feedback identification model.

The models and algorithms employed herein can be trained in a variety of manners, e.g., via supervised learning, semi-supervised learning, or unsupervised learning.

In a first example, the network system 120 may employ the training module 330 to train the key-point identification model using a training set stored in the training store 350. The training set may be a group of images of users embodying various movements. The movements may be labelled with various key-points and/or key-point analytics. The training module trains the key-point identification model such that the key-point identification model associates latent information in the images with those key-points. Once trained, the key-point identification model recognizes that latent information in input images and labels the images with the corresponding key-points and key-point analytics.

In a second example, the network system 120 may employ the training module 330 to train the feedback determination model using a training set stored in the training store 350 and feedback stored in the feedback store 360. The training set may include a number of previously codified pose sequences and/or pose sequence signatures and their associated key-points, key-point analytics, and user states. in, the training set may be a set of codified historical pose sequences and pose sequence signatures from a historical cohort. Each of these training sequences may be associated with feedback. For instance, a coach or fitness professional may have analyzed one of the historical pose sequences and provided appropriate feedback for that pose sequence. The training module 330 then begins to generate various relationships between the feedback, codified pose sequences, pose sequence signatures, key-points, key-point analytics, and user states. The relationships, in effect, identify various aspects of the underlying information that are related such that feedback for one pose sequence may be associated with a similar pose sequence. In this manner, the feedback model is configured to determine feedback for a pose sequence that is contextually similar to a historical pose sequence.

### IV. Example Feedback Generation Method

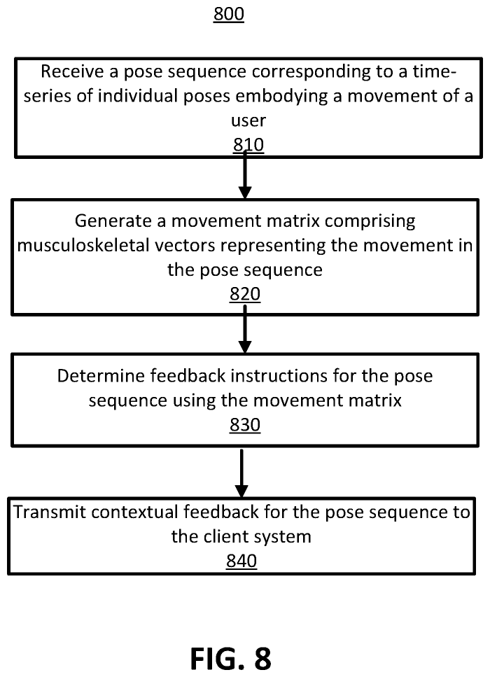

FIG. 8 illustrates a workflow for determining feedback for a pose sequence using the feedback module, according to one example embodiment. The workflow 800 may include additional or fewer steps, and the steps may occur in a different order. Moreover, the described steps may repeat or may be omitted depending on the context and implementation of the network system 120.

The network system 120 receives 810 a pose sequence from the client system 110. The pose sequence includes a plurality of poses. The plurality of poses embodies a time-series representation of the poses which embody a movement of the user. In various configurations, the poses may embody the movement in a set of images, a video, a set of vectors, etc. Each pose in the plurality of poses represents the musculoskeletal structure of the user during a particular moment of the movement.

The network system 120 generates 820 a movement matrix. The movement matrix includes a set of musculoskeletal vectors representing the movement of the user. Each musculoskeletal vector in the matrix corresponds to a pose of the pose sequence. Moreover, each musculoskeletal vector represents the musculoskeletal structure of the user in the corresponding pose.

The network system 120 determines 830 feedback instructions for the pose sequence. To do so, the network system inputs the movement matrix and a user state describing characteristics of the user into a feedback model.

The feedback model quantifies distances between the movement matrix and historical matrices in a historical cohort. The historical matrices represent historical users embodying the movement of users having a historical user state similar to the user. That is, the feedback model “compares” the movement matrix to historical movement matrices to determine a degree of similarity, i.e., closeness, between movements.

The feedback model selects a historical matrix having a closest distance to the movement matrix as a guidepost matrix. The feedback model selects at least one feedback item associated with the guidepost matrix as a contextual feedback item for the user.

The network system 120 transmits 840 the contextual feedback item to the client system.

### V. Example Computer Systems

FIG. 8 is a block diagram illustrating components of an example machine for reading and executing instructions from a machine-readable medium, according to one example embodiment. Specifically, FIG. 8 shows a diagrammatic representation of network system 120 and client system 110 in the example form of a computer system 900. The computer system 900 can be used to execute instructions 924 (e.g., program code or software) for causing the machine to perform any one or more of the methodologies (or processes) described herein. In alternative embodiments, the machine operates as a standalone device or a connected (e.g., networked) device that connects to other machines. In a networked deployment, the machine may operate in the capacity of a server machine or a client machine in a server-client network environment, or as a peer machine in a peer-to-peer (or distributed) network environment.

The machine may be a server computer, a client computer, a personal computer (PC), a tablet PC, a set-top box (STB), a smartphone, an internet of things (IOT) appliance, a network router, switch or bridge, or any machine capable of executing instructions 924 (sequential or otherwise) that specify actions to be taken by that machine. Further, while only a single machine is illustrated, the term “machine” shall also be taken to include any collection of machines that individually or jointly execute instructions 924 to perform any one or more of the methodologies discussed herein.

The example computer system 900 includes one or more processing units (generally processor 902). The processor 902 is, for example, a central processing unit (CPU), a graphics processing unit (GPU), a digital signal processor (DSP), a controller, a state machine, one or more application specific integrated circuits (ASICs), one or more radio-frequency integrated circuits (RFICs), or any combination of these. The computer system 900 also includes a main memory 904. The computer system may include a storage unit 916. The processor 902, memory 904, and the storage unit 916 communicate via a bus 908.

In addition, the computer system 906 can include a static memory 906, a graphics display 910 (e.g., to drive a plasma display panel (PDP), a liquid crystal display (LCD), or a projector). The computer system 900 may also include alphanumeric input device 912 (e.g., a keyboard), a cursor control device 914 (e.g., a mouse, a trackball, a joystick, a motion sensor, or other pointing instrument), a signal generation device 918 (e.g., a speaker), and a network interface device 920, which also are configured to communicate via the bus 908.

The storage unit 916 includes a machine-readable medium 922 on which is stored instructions 924 (e.g., software) embodying any one or more of the methodologies or functions described herein. For example, the instructions 924 may include the functionalities of modules of the network system 120 described in FIG. 2. The instructions 924 may also reside, completely or at least partially, within the main memory 904 or within the processor 902 (e.g., within a processor's cache memory) during execution thereof by the computer system 900, the main memory 904 and the processor 902 also constituting machine-readable media. The instructions 924 may be transmitted or received over a network 926 via the network interface device 920.

### VI. Additional Considerations

The aforementioned contextual feedback generation systems provide a variety of benefits overall traditional machine vision recognition systems. In a first example, the described system allows contextual feedback to be provided to a user based on the specific context of that user. That is, the feedback is tailored to the sex, skill level, desires, etc., of the user such that the feedback is more useful for the user. Additionally, because the pose sequence is codified as a vector or matrix, it allows the system to more efficiently search the various machine learning algorithms described above in determining feedback for the user. Finally, the described system access, generates, and modifies feedback based on a user's feedback preferences. That is, if a user prefers video feedback, the described system will access, generate, or modify feedback such that it is presented according to their preference.

In the description above, for purposes of explanation, numerous specific details are set forth in order to provide a thorough understanding of the illustrated system and its operations. It will be apparent, however, to one skilled in the art that the system can be operated without these specific details. In other instances, structures and devices are shown in block diagram form in order to avoid obscuring the system.

Reference in the specification to “one embodiment” or “an embodiment” means that a particular feature, structure, or characteristic described in connection with the embodiment is included in at least one embodiment of the system. The appearances of the phrase “in one embodiment” in various places in the specification are not necessarily all referring to the same embodiment.

Some portions of the detailed descriptions are presented in terms of algorithms or models and symbolic representations of operations on data bits within a computer memory. An algorithm is here, and generally, conceived to be steps leading to a desired result. The steps are those requiring physical transformations or manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Some of the operations described herein are performed by a computer physically mounted within a machine. This computer may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of non-transitory computer readable storage medium suitable for storing electronic instructions.

The figures and the description above relate to various embodiments by way of illustration only. It should be noted that from the following discussion, alternative embodiments of the structures and methods disclosed herein will be readily recognized as viable alternatives that may be employed without departing from the principles of what is claimed.

One or more embodiments have been described above, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

Some embodiments may be described using the expression “coupled” and “connected” along with their derivatives. It should be understood that these terms are not intended as synonyms for each other. For example, some embodiments may be described using the term “connected” to indicate that two or more elements are in direct physical or electrical contact with each other. In another example, some embodiments may be described using the term “coupled” to indicate that two or more elements are in direct physical or electrical contact. The term “coupled,” however, may also mean that two or more elements are not in direct physical or electrical contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article or apparatus that comprises a list of elements is not necessarily limited to only those elements but may include other elements not expressly listed or inherent to such process, method, article or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B is true (or present).

In addition, use of the “a” or “an” are employed to describe elements and components of the embodiments herein. This is done merely for convenience and to give a general sense of the system. This description should be read to include one or at least one and the singular also includes the plural unless it is obvious that it is meant otherwise.

Upon reading this disclosure, those of skill in the art will appreciate still additional alternative structural and functional designs. Thus, while particular embodiments and applications have been illustrated and described, it is to be understood that the disclosed embodiments are not limited to the precise construction and components disclosed herein. Various modifications, changes and variations, which will be apparent to those, skilled in the art, may be made in the arrangement, operation and details of the method and apparatus disclosed herein without departing from the spirit and scope defined in the appended claims.

What is claimed is:

1. A method for generating contextual feedback for movements, the method comprising:
receiving, at a network system from a client system, a pose sequence comprising a plurality of poses, the plurality of poses corresponding to a time-series of individual poses embodying a movement of a user, each pose representing a musculoskeletal structure of the user during the movement;
generating a movement matrix comprising a set of musculoskeletal vectors representing the movement of the user, each musculoskeletal vector corresponding to a pose of the pose sequence, and each musculoskeletal vector representing the musculoskeletal structure of the user in the corresponding pose;
determining feedback instructions for the pose sequence by inputting the movement matrix and a user state describing characteristics of the user into a feedback model, the feedback model configured to:
quantify distances between the movement matrix and historical movement matrices in a historical cohort, the historical movement matrices representing historical users embodying the movement of users having a historical user state similar to the user;
select a historical matrix having a closest distance to the movement matrix as a guidepost matrix;
select at least one feedback item associated with the guidepost matrix as a contextual feedback item for the user;
transmitting the contextual feedback item to the client system.

2. The method of claim 1, further comprising:
capturing a plurality of images of the user, the plurality of images representing a time series of individual poses embodying the movement of the user; and
for each image in the plurality of images, codifying a pose represented in the image as a musculoskeletal vector representing the musculoskeletal structure of the user in the pose.

3. The method of claim 2, wherein codifying the pose represented in the image as a musculoskeletal vector comprises:
inputting the image into a key-point identification model trained to input images of users executing movements and output a musculoskeletal vector representing movements executed by users in images.

4. The method of claim 1, wherein:
each historical movement matrix comprises a set of historical musculoskeletal vectors representing a historical movement of a historical user,
each historical musculoskeletal vector in the historical movement matrix corresponds to the pose of the pose sequence, and
each historical musculoskeletal vector represents a musculoskeletal structure of the historical user in the corresponding pose.

5. The method of claim 1, wherein selecting at least one feedback item associated with the guidepost matrix as the contextual feedback item for the user is based on user preferences for the user.

6. The method of claim 1, wherein selecting at least one feedback item associated with the guidepost matrix as the contextual feedback item for the user comprises:
generating the at least one feedback item at the network system; and
transmitting the at least one feedback item to the client system.

7. The method of claim 1, wherein selecting at least one feedback item associated with the guidepost matrix as the contextual feedback item for the user comprises:
accessing the at least one feedback item from a feedback store at the network system; and
transmitting the at least one feedback item to the client system.

8. The method of claim 1, wherein selecting at least one feedback item associated with the guidepost matrix as the contextual feedback item for the user comprises:
accessing the at least one feedback item from a feedback store at the network system;
modifying, using the network system, the at least one feedback; and
transmitting the at least one feedback item to the client system.

9. The method of claim 1, wherein the user state comprises any of:
an age of the user;
a fitness level of the user;
a skill level of the user;
a sex of the user;
a size of the user; and
a weight of the user.

10. The method of claim 1, wherein the user state comprises a movement goal of the user.

11. A non-transitory computer-readable storage medium storing computer program instructions for generating contextual feedback for movements, the computer program instructions, when executed by a processor, cause the processor to:
receive, at a network system from a client system, a pose sequence comprising a plurality of poses, the plurality of poses corresponding to a time-series of individual poses embodying a movement of a user, each pose representing a musculoskeletal structure of the user during the movement;
generate a movement matrix comprising a set of musculoskeletal vectors representing the movement of the user, each musculoskeletal vector corresponding to a pose of the pose sequence, and each musculoskeletal vector representing the musculoskeletal structure of the user in the corresponding pose;
determine feedback instructions for the pose sequence by inputting the movement matrix and a user state describing characteristics of the user into a feedback model, the feedback model configured to:
quantify distances between the movement matrix and historical movement matrices in a historical cohort, the historical movement matrices representing historical users embodying the movement of users having a historical user state similar to the user;
select a historical matrix having a closest distance to the movement matrix as a guidepost matrix;
select at least one feedback item associated with the guidepost matrix as a contextual feedback item for the user;
transmit the contextual feedback item to the client system.

12. The non-transitory computer-readable storage medium of claim 11, wherein the computer program instructions, when executed by the processor, further cause the processor to:
capturing a plurality of images of the user, the plurality of images representing a time series of individual poses embodying the movement of the user; and
for each image in the plurality of images, codifying a pose represented in the image as a musculoskeletal vector representing the musculoskeletal structure of the user in the pose.

13. The non-transitory computer-readable storage medium of claim 12, wherein the computer program instructions causing the processor to codify the pose represented in the image as a musculoskeletal vector, when executed, further cause the processor to:
inputting the image into a key-point identification model trained to input images of users executing movements and output a musculoskeletal vector representing movements executed by users in images.

14. The non-transitory computer-readable storage medium of claim 11, wherein:
each historical movement matrix comprises a set of historical musculoskeletal vectors representing a historical movement of a historical user,
each historical musculoskeletal vector in the historical movement matrix corresponds to the pose of the pose sequence, and
each historical musculoskeletal vector represents a musculoskeletal structure of the historical user in the corresponding pose.

15. The non-transitory computer-readable storage medium of claim 11, wherein selecting at least one feedback item associated with the guidepost matrix as the contextual feedback item for the user is based on user preferences for the user.

16. The non-transitory computer-readable storage medium of claim 11, wherein the computer program instructions for selecting at least one feedback item associated with the guidepost matrix as the contextual feedback item for the user, when executed, further causes the processor to:
generate the at least one feedback item at the network system; and
transmit the at least one feedback item to the client system.

17. The non-transitory computer-readable storage medium of claim 11, wherein the computer program instructions for selecting at least one feedback item associated with the guidepost matrix as the contextual feedback item for the user, when executed, further causes the processor to:
access the at least one feedback item from a feedback store at the network system; and
transmit the at least one feedback item to the client system.

18. The non-transitory computer-readable storage medium of claim 11, wherein the computer program instructions for selecting at least one feedback item associated with the guidepost matrix as the contextual feedback item for the user, when executed, further causes the processor to:
access the at least one feedback item from a feedback store at the network system;
modify, using the network system, the at least one feedback; and
transmit the at least one feedback item to the client system.

19. The non-transitory computer-readable storage medium of claim 11, wherein the user state comprises any of:
an age of the user;
a fitness level of the user;
a skill level of the user,
a sex of the user,
a size of the user, and
a weight of the user.

20. A system comprising:
a processor, and
a non-transitory computer-readable storage medium storing computer program instructions for generating contextual feedback for movements, the computer program instructions, when executed by a processor, cause the processor to:
receive, at a network system from a client system, a pose sequence comprising a plurality of poses, the plurality of poses corresponding to a time-series of individual poses embodying a movement of a user, each pose representing a musculoskeletal structure of the user during the movement;
generate a movement matrix comprising a set of musculoskeletal vectors representing the movement of the user, each musculoskeletal vector corresponding to a pose of the pose sequence, and each musculoskeletal vector representing the musculoskeletal structure of the user in the corresponding pose;
determine feedback instructions for the pose sequence by inputting the movement matrix and a user state describing characteristics of the user into a feedback model, the feedback model configured to:
quantify distances between the movement matrix and historical movement matrices in a historical cohort, the historical movement matrices representing historical users embodying the movement of users having a historical user state similar to the user;
select a historical matrix having a closest distance to the movement matrix as a guidepost matrix;
select at least one feedback item associated with the guidepost matrix as a contextual feedback item for the user;
transmit the contextual feedback item to the client system.
